(19) United States
(12) Patent Application Publication
(10) Pub. No.: US 2025/0167635 A1
(43) Pub. Date: May 22, 2025

(54) ROTARY ELECTRIC MACHINE

(71) Applicant: HONDA MOTOR CO., LTD., Tokyo (JP)

(72) Inventors: Yoshiro Tazawa, Wako-shi (JP); Kentaro Fukui, Wako-shi (JP); Takashi Wakui, Wako-shi (JP)

(21) Appl. No.: 18/895,800

(22) Filed: Sep. 25, 2024

(30) Foreign Application Priority Data
Nov. 22, 2023 (JP) 2023-198603

(51) Int. Cl. H02K 9/197

(52) U.S. Cl. CPC H02K 9/197

(57) ABSTRACT

A rotary electric machine includes a stator, a rotor, a first liquid room, and a second liquid room. The stator has a stator core and a coil. A plurality of teeth portions and a plurality of slots are provided alternately on an inner circumferential portion of the stator core. A cooling liquid that is introduced into the first liquid room flows into the second liquid room through the plurality of slots. An outflow regulation portion that regulates an outflow of the cooling liquid from the first liquid room to an inner region in a radial direction of a slot is provided on at least a first end side in an axis direction of the stator core. In a slot portion on a first end side in the axis direction, a flow path opening area between the outflow regulation portion and a coil that is located at an innermost side in the radial direction is set to be smaller than a flow path opening area between the coils that are adjacent to each other in the slot.

### CROSS-REFERENCE TO RELATED APPLICATION

Priority is claimed on Japanese Patent Application No. 2023-198603, filed on Nov. 22, 2023, the contents of which are incorporated herein by reference.

### BACKGROUND

### Field of the Invention

The present invention relates to a rotary electric machine.

### Background

As a rotary electric machine such as an electric motor or an electricity generator, a rotary electric machine in which a rotor is rotatably arranged at an inner side in a radial direction of a stator having an annular shape is known. The stator includes a stator core and a coil that is wound around the stator core. In the stator core, for example, a back yoke having a cylindrical shape and a plurality of teeth portions that protrude inward in the radial direction from the back yoke are integrally formed. A slot is formed between the teeth portions that are adjacent to each other in a circumferential direction. The coil is wound around each teeth portion through slots arranged on both sides of the teeth portion.

In this type of rotary electric machine, since the temperature of the coil becomes high at the time of use, it is desired to efficiently cool the coil. As a method for efficiently cooling the coil of the rotary electric machine, a method of causing a cooling liquid to continuously flow through the inside of a rotary electric machine case that accommodates the stator is known (for example, refer to PCT International Publication No. WO 2021/032238).

### SUMMARY

In the rotary electric machine described above, when the cooling liquid is caused to flow into the rotary electric machine case, a liquid room may be provided on each of a first end side and a second end side in an axis direction of the stator core, and the slot of the stator core may be used as a passage for causing the cooling liquid to flow from one liquid room to another liquid room. In this case, when the cooling liquid flows in the slot, it is possible to efficiently cool a circumferential region of the coil in the slot.

However, when the slot is used as a passage through which the cooling liquid flows, the cooling liquid that flows out to an inner side in a radial direction from the slot enters an air gap between the rotor and the stator, and smooth rotation of the rotor is hindered. Therefore, when the slot is used as the passage through which the cooling liquid flows, it is necessary to provide a complex seal structure for preventing the leakage of the cooling liquid on each slot.

In the case of this method, manufacturing of the stator becomes complicated, and the improvement of a manufacturing efficiency of the rotary electric machine is easily hindered.

An embodiment of the present invention aims at providing a rotary electric machine that can prevent an excessive outflow of a cooling liquid in an outer circumferential direction of a rotor from a slot of a stator core by a simple configuration and can contribute to the improvement of an energy efficiency.

A rotary electric machine according to an aspect of the present invention is a rotary electric machine including: a stator having: a stator core which has a cylindrical shape and in which a plurality of teeth portions and a plurality of slots are provided alternately on an inner circumferential portion; and a plurality of coils that are wound around each of the teeth portions through the slots; a rotor that is rotatably arranged on an inside in a radial direction of the stator; a first liquid room that is provided so as to face a first end surface in an axis direction of the stator core; and a second liquid room that is provided so as to face a second end surface in the axis direction of the stator core, wherein a cooling liquid that is introduced into the first liquid room flows into the second liquid room through the plurality of slots, an outflow regulation portion that regulates an outflow of the cooling liquid from the first liquid room to an inner region in the radial direction of the slot is provided on at least a first end side in the axis direction of the stator core, and in a slot portion on a first end side in the axis direction, a flow path opening area between the outflow regulation portion and a coil among the plurality of coils that is located at an innermost side in the radial direction in a slot among the plurality of slots is set to be smaller than a flow path opening area between the coils that are adjacent to each other in the slot.

According to the configuration described above, the cooling liquid in the first liquid room flows into the second liquid room through the plurality of slots of the stator core, and at this time, the coil in the slot is cooled by the cooling liquid. At this time, at a first end side in the axis direction of the stator core, the outflow of the cooling liquid from the first liquid room to the inner region in the radial direction of the slot is regulated by the outflow regulation portion. In the slot portion on the first end side in the axis direction, the flow path opening area between the outflow regulation portion and the coil that is located at the innermost side in the radial direction is set to be smaller than the flow path opening area between the coils that are adjacent to each other in the slot. Therefore, the flow rate of the cooling liquid that flows into the inner region in the radial direction of the slot from the first liquid room becomes smaller than a flow rate of the cooling liquid that flows to the second liquid room side through a gap between the coils from the first liquid room. Accordingly, an excessive outflow of the cooling liquid in an outer circumferential direction of the rotor from the slot of the stator core is prevented.

The rotary electric machine described above may include, at an inside of the first liquid room, a guide member that guides the cooling liquid to the slot on the first end side in the axis direction of the stator core, wherein the guide member may have a shield portion that is in contact with or is close to the first end surface in the axis direction of the stator core and reduces a flow of the cooling liquid to the inner region in the radial direction of the slot at the first end side in the axis direction of the stator core, and the shield portion may constitute the outflow regulation portion.

In this case, in the guide member that guides the cooling liquid to the slot on the first end side in the axis direction of the stator core, the shield portion is in contact with or is close to the first end surface in the axis direction of the stator core. Thereby, the flow of the cooling liquid to the inner region in the radial direction of the slot at the first end side in the axis direction of the stator core is reduced by the shield portion. As a result, the flow rate of the cooling liquid that flows from the first liquid room to the inner region in the radial direction of the slot becomes smaller than the flow rate of the cooling liquid that flows from the first liquid room through a gap between the coils to the second liquid room side. Accordingly, when the present configuration is employed, it is possible to prevent an excessive outflow of the cooling liquid in an outer circumferential direction of the rotor from the slot without changing the shape of the slot portion of the stator core, and it becomes possible to manufacture the rotary electric machine at low costs.

The guide member may be locked in a contact state by the stator core.

In this case, since the guide member is locked in the contact state by the stator core, the guide member and the stator core vibrate in the same phase. Therefore, a friction due to the backlash or contact does not easily occur between the guide member and the stator core.

A contact seat that is in contact with the first end surface in the axis direction of the stator core may be provided on the guide member.

In this case, when the cooling liquid flows through the plurality of slots from the first liquid room to the second liquid room, a liquid pressure in the first liquid room becomes higher than a liquid pressure in the second liquid room. Therefore, the guide member is pressed in a direction of the second liquid room by a pressure difference of the cooling liquids in the first liquid room and the second liquid room. At this time, the contact seat of the guide member comes into contact with the first end surface in the axis direction of the stator core, and the guide member is locked by the stator core. Accordingly, when the present configuration is employed, even when a space for locking the guide member to the stator core is narrow, the guide member can be reliably locked by the stator core. Further, in the present configuration, since another component such as a fastening member is not required in order to lock the guide member to the stator core, an assembly work at the time of manufacturing the rotary electric machine is also facilitated.

An inner side in the radial direction of the first liquid room may be formed and separated by a first inner circumferential wall, an inner side in the radial direction of the second liquid room may be formed and separated by a second inner circumferential wall, an annular partition wall that partitions an inner circumferential surface of the stator core and an outer circumferential surface of the rotor may be provided on an outer circumferential surface of the first inner circumferential wall and an outer circumferential surface of the second inner circumferential wall, and the shield portion may be formed on part of the annular partition wall.

In this case, the inner circumferential surface of the stator core and the rotor are partitioned by the annular partition wall that is provided on the first inner circumferential wall and the second inner circumferential wall. Therefore, even if the cooling liquid that flows in the plurality of slots flows out to the inner region in the radial direction of the slot, the cooling liquid does not flow to the outer circumferential surface of the rotor. Further, when the cooling liquid that flows in the plurality of slots excessively flows out to the inner region in the radial direction of the slot, there is a concern of the case where the annular partition wall is deformed by being pressed inward in the radial direction by the cooling liquid. However, in the present configuration, since the shield portion is formed on part of the annular partition wall, an excessive outflow of the cooling liquid to the inner region in the radial direction of the slot is prevented by the shield portion. Accordingly, when the present configuration is employed, it is possible to prevent the annular partition wall from being deformed by being pressed inward in the radial direction by the cooling liquid.

A portion of the slot that is arranged on the first end side in the axis direction of the stator core may be constituted of a closed slot in which an inner side in the radial direction of the stator core is closed, and a slot close portion that closes the inner side in the radial direction of the closed slot may constitute the outflow regulation portion.

In this case, the portion of the stator core that is arranged on the first end side in the axis direction is constituted of the closed slot, and the flow of the cooling liquid to the inner region in the radial direction of the slot is prevented by the slot close portion at the inner side in the radial direction of the closed slot. As a result, a flow rate of the cooling liquid that flows into the inner region in the radial direction of the slot from the first liquid room becomes smaller than a flow rate of the cooling liquid that flows to the second liquid room side through a gap between the coils from the first liquid room.

The slot at a further inner side in the axis direction than a portion as the closed slot may be constituted of an open slot that opens to an inner circumferential side of the stator core, and a cooling liquid escape portion that communicates with a portion of the slot as the open slot may be provided on the stator core.

In this case, part of the cooling liquid that has passed through the closed slot at the first end side in the axis direction of the stator core flows out to the outer circumferential surface direction of the rotor through an opening on the inner side in the radial direction of the open slot. However, the portion as the open slot communicates with the cooling liquid escape portion of the stator core. Therefore, part of the cooling liquid that has flowed into the open slot is discharged to the outside through the cooling liquid escape portion of the stator core, and excessive outflow to the outer circumferential surface side of the rotor is prevented.

A recess groove that extends along the axis direction of the stator core may be formed on facing surfaces of the coils that are arranged to be adjacent to each other in the slot.

In this case, since the recess groove is formed on the facing surfaces of the coils that are arranged to be adjacent to each other in the slot, it is possible to easily and reliably enlarge the flow path opening area between the coils that are adjacent to each other. Accordingly, when the present configuration is employed, the flow path opening area between the outflow regulation portion and the coil that is located at the innermost side in the radial direction in the slot can be easily and reliably made smaller than the flow path opening area between the coils that are adjacent to each other.

In the rotary electric machine according to the aspect of the present invention, in the slot portion on a first end side in the axis direction, the flow path opening area between the outflow regulation portion and the coil that is located at the innermost side in the radial direction is set to be smaller than the flow path opening area between the coils. Therefore, the flow rate of the cooling liquid that flows into the inner region in the radial direction of the slot from the first liquid room can be made smaller than the flow rate of the cooling liquid that flows to the second liquid room side through the gap between the coils from the first liquid room. Accordingly, when the rotary electric machine according to the aspect of the present invention is employed, it is possible to prevent an excessive outflow of the cooling liquid in the outer circumferential direction of the rotor from the slot of the stator core by a simple configuration, and it is possible to contribute to the improvement of the energy efficiency.

### BRIEF DESCRIPTION OF THE DRAWINGS

FIG. 1 is a longitudinal cross-sectional view of a rotary electric machine of a first embodiment.

FIG. 2 is an enlarged view of a II portion of FIG. 1 of the rotary electric machine of the first embodiment.

FIG. 3 is a cross-sectional view along a III-III line of FIG. 2 of the rotary electric machine of the first embodiment.

FIG. 4 is a cross-sectional view of a rotary electric machine of a second embodiment corresponding to FIG. 2 of the first embodiment.

FIG. 5 is a cross-sectional view along a V-V line of FIG. 4 of the rotary electric machine of the second embodiment.

FIG. 6 is a cross-sectional view of a rotary electric machine of a third embodiment corresponding to FIG. 2 of the first embodiment.

FIG. 7 is a longitudinal cross-sectional view of a rotary electric machine of a fourth embodiment.

FIG. 8 is an enlarged cross-sectional view of a VIII portion of FIG. 7 of the rotary electric machine of the fourth embodiment.

FIG. 9 is a cross-sectional view along a IX-IX line of FIG. 7 of the rotary electric machine of the fourth embodiment.

FIG. 10 is a cross-sectional view along a X-X line of FIG. 7 of the rotary electric machine of the fourth embodiment.

FIG. 11 is a cross-sectional view along a XI-XI line of FIG. 8 of the rotary electric machine of the fourth embodiment.

FIG. 12 is a cross-sectional view along a XII-XII line of FIG. 8 of the rotary electric machine of the fourth embodiment.

### DESCRIPTION OF EMBODIMENTS

Hereinafter, embodiments of the present invention will be described with reference to the drawings. In the embodiments described below, common parts are denoted by the same reference numerals, and redundant descriptions are partially omitted.

### First Embodiment

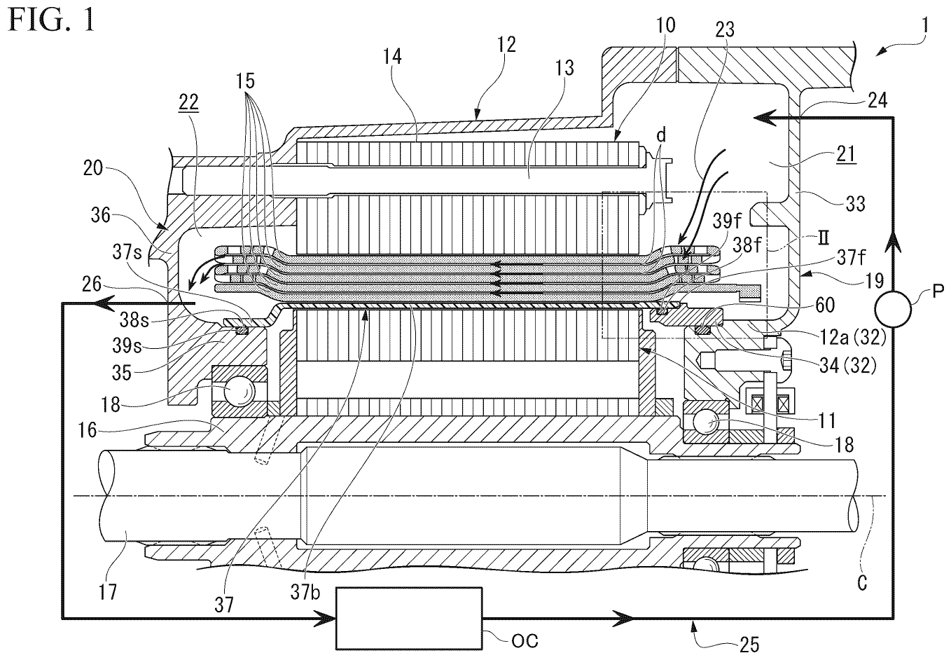

FIG. 1 is a longitudinal cross-sectional view of a rotary electric machine 1 of the present embodiment.

The rotary electric machine 1 of the present embodiment includes a stator 10 and a rotor 11. The stator 10 and the rotor 11 are accommodated in a rotary electric machine case 12. The stator 10 is fixed to an inside of the rotary electric machine case 12 by the fastening using a bolt 13 or the like. The stator 10 includes a stator core 14 having a cylindrical shape and a plurality of coils 15 that are wound around the stator core 14. The rotor 11 is rotatably arranged at an inside in a radial direction of the stator core 14 (stator 10).

A permanent magnet (not shown) is attached to the vicinity of an outer circumferential surface of the rotor 11. Further, the rotor 11 is rotatably supported integrally by a rotation shaft 17 via a sleeve 16. The rotation shaft 17 is an output shaft when the rotary electric machine 1 is used as a motor. The rotation shaft 17 is a power input shaft when the rotary electric machine 1 is used as an electricity generator. The rotation shaft 17 and the sleeve 16 are rotatably supported by the rotary electric machine case 12 via a bearing 18.

In the following description, a direction parallel to a rotation axis line C of the rotor 11 is referred to as an axis direction, a rotation direction of the rotor 11 is referred to as a circumferential direction, and a radial direction of the rotor 11 orthogonal to the axis direction and the circumferential direction is referred to as a radial direction.

A first side case 19 and a second side case 20 that have an annular shape are arranged on a first end side and a second end side in the axis direction of the stator core 14. Main parts of the first side case 19 and the second side case 20 are formed of the rotary electric machine case 12.

The first side case 19 covers a first end surface in the axis direction of the stator core 14 and an exposure portion of the coil 15 that protrudes from the first end surface from the outside. The first side case 19 forms a first liquid room 21 having an annular shape together with the first end surface in the axis direction of the stator core 14. An introduction port 24 for introducing a cooling liquid 23 into the first liquid room 21 is formed on the first side case 19. The introduction port 24 is connected to a circulation circuit 25 of the cooling liquid 23. The cooling liquid 23 that is introduced into the first liquid room 21 cools the exposure portion of the coil 15 that protrudes from the first end surface of the stator core 14, then passes through the inside of the stator core 14, and flows into a second end side in the axis direction of the stator core 14.

The second side case 20 covers a second end surface in the axis direction of the stator core 14 and an exposure portion of the coil 15 that protrudes from the second end surface from the outside. The second side case 20 forms a second liquid room 22 having an annular shape together with the second end surface in the axis direction of the stator core 14. The cooling liquid 23 that is introduced into the first liquid room 21 flows into the second liquid room 22 through the inside of the stator core 14. The cooling liquid 23 that is introduced into the second liquid room 22 cools the exposure portion of the coil 15 that protrudes from the second end surface of the stator core 14. A discharge port 26 for discharging the cooling liquid 23 in the second liquid room 22 to the outside is formed on the second side case 20. The discharge port 26 is connected to the circulation circuit 25 of the cooling liquid 23. The cooling liquid 23 that has cooled the coil 15 in the second liquid room 22 is caused to return to the circulation circuit 25 from the discharge port 26.

In the circulation circuit 25, a supply pump P is connected to a middle of the circuit. A heat exchanger OC that cools the cooling liquid 23 by a heat exchange with outside air is connected to an upstream side of the supply pump P in the circulation circuit 25. A downstream side of the supply pump P is connected to the introduction port 24. Further, an upstream side of the heat exchanger OC in the circulation circuit 25 is connected to the discharge port 26.

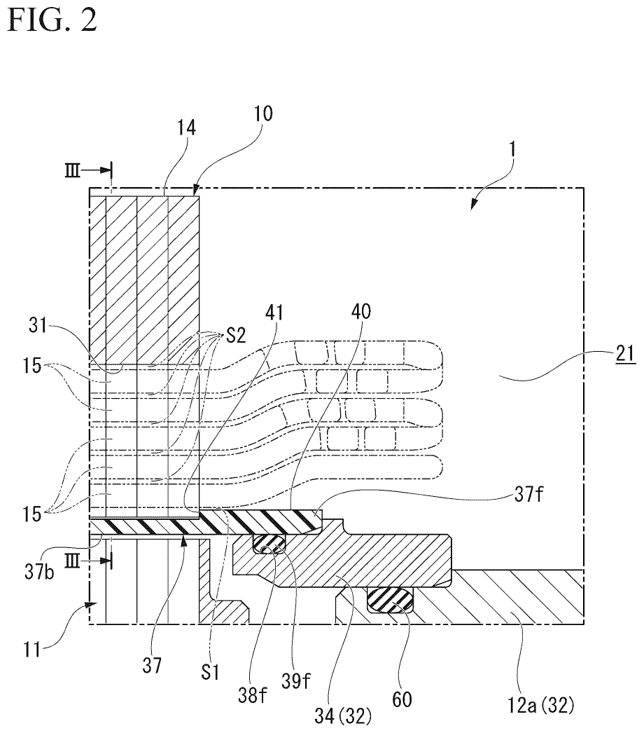

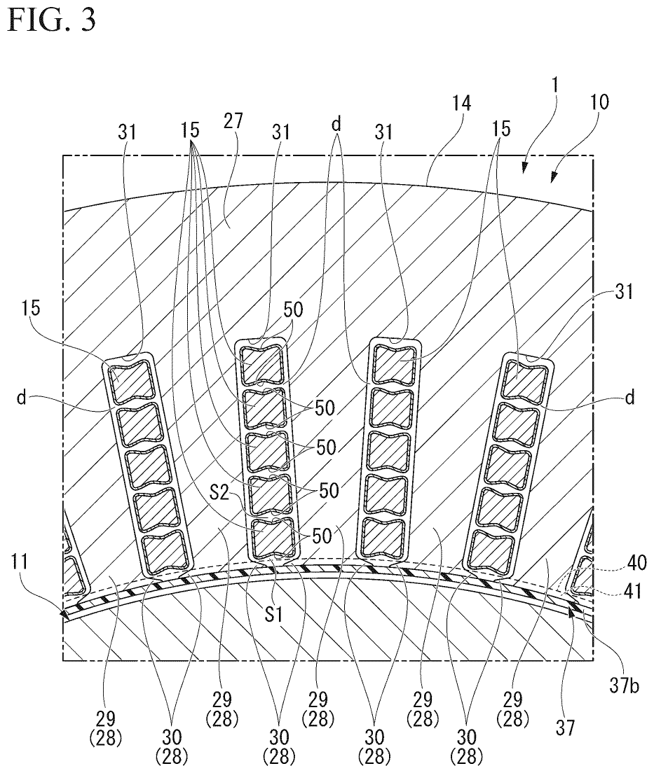

FIG. 2 is an enlarged cross-sectional view showing a II portion of FIG. 1 of the rotary electric machine 1. FIG. 3 is a cross-sectional view along a III-III line of FIG. 2 of the rotary electric machine 1. In FIG. 2, the coil 15 is described by an imaginary line.

The stator core 14 is formed, for example, by laminating a plurality of electromagnetic steel plates in the axis direction. In the stator core 14, as shown in FIG. 3, a back yoke 27 having a cylindrical shape and a plurality of teeth portions 28 that protrude inward in the radial direction from an inner circumferential portion of the back yoke 27 are integrally molded. The back yoke 27 is formed such that a cylinder center is matched with the rotation axis line C.

As shown in FIG. 3, the teeth portions 28 are arranged to be spaced apart from each other in the circumferential direction. The teeth portion 28 is formed in a T shape when seen from the axis direction. That is, in the teeth portion 28, a teeth main body 29 that protrudes inward in the radial direction from the inner circumferential portion of the back yoke 27 and a flange portion 30 that projects to both sides in the circumferential direction from an inner end in the radial direction in the teeth main body 29 are integrally molded.

A slot 31 in which an inner side in the radial direction is opened is formed between the teeth portions 28 that are adjacent to each other in the circumferential direction. The slot 31 is formed by being surrounded by side walls that face each other of the teeth portions 28 that are adjacent to each other and an inner circumferential wall of the back yoke 27. The side wall of each teeth portion 28 is formed of a side portion of the teeth main body 29 and a side section of the flange portion 30. A portion of the slot 31 that is formed of the side portions of the right and left teeth main bodies 29 has a substantially constant width. Further, the width of a portion of the slot 31 that is formed of the side sections of the right and left flange portions 30 is narrower than the width of the portion that is formed of the side portions of the right and left teeth main bodies 29.

In the coil 15, for example, three phases which are a U-phase, a V-phase, and a W-phase are provided. The coil 15 is constituted, for example, by connecting a plurality of segment coils to each other. In the segment coil, a core wire is covered by an insulation film. The segment coil is constituted of a rectangular wire. That is, a cross-sectional shape along the radial direction in each segment coil is formed in a substantially rectangular shape.

The segment coil is a coil element in which two slot insertion portions (segment conductors) that are inserted through the slots 31 that are adjacent to each other on the stator core 14 are integrally connected at a second end side in the axis direction of the stator core 14. An end section of each slot insertion portion (segment conductor) that protrudes from the slot 31 to a first end side in the axis direction of the stator core 14 is joined to an end section of the slot insertion portion of another segment coil by TIG welding, laser welding, or the like. Thereby, the plurality of segment coils constitute a continuous long coil.

As shown in FIG. 3, the slot insertion portions of the plurality of coils 15 that are inserted through the same slot 31 are aligned in a line along the radial direction. In the present embodiment, for example, five coils 15 are inserted through the same slot 31. However, the number of coils 15 that are inserted through the same slot 31 is not limited to this and can be arbitrarily set.

A gap d that communicates with a first end side and a second end side in the axis direction of the stator core 14 is ensured at the inside of each slot 31 in which the plurality of coils 15 are aligned. The gap d is ensured between an inner surface of the slot 31 and the plurality of coils 15 and between the coils 15 that are adjacent to each other in the slot 31.

The gap d is a gap that causes the first liquid room 21 and the second liquid room 22 shown in FIG. 1 to communicate with each other and functions so as to cause the cooling liquid 23 that is introduced into the first liquid room 21 to the second liquid room 22 side. The cooling liquid 23 that flows in the slot 31 absorbs the heat of the slot insertion portion of each coil 15.

Further, a recess groove 50 that extends along the axis direction of the stator core 14 is formed on surfaces that face inward and outward in the radial direction of each coil 15 arranged in the slot 31. The recess groove 50 is formed to be recessed in a substantially circular arc shape toward a middle region in a width direction of the coil 15. The recess groove 50 is formed on facing surfaces of the coils 15 that are adjacent to each other in the radial direction when the plurality of coils 15 are arranged in the slot 31. Therefore, a flow path that extends in the axis direction is ensured between the coils 15 that are arranged to be adjacent to each other by the recess groove 50 of each facing surface.

Here, as shown in FIG. 1 and FIG. 2, the first side case 19 on a first end side in the axis direction of the stator core 14 includes a first inner circumferential wall 32 that faces the first liquid room 21. The first inner circumferential wall 32 protrudes in a cylindrical shape from an inner end portion in the radial direction of an end side wall 33 of the first side case 19 located at an outer end in the axis direction of the first liquid room 21 toward a first end surface in the axis direction of the rotor 11. In the case of the present embodiment, the first inner circumferential wall 32 is constituted of a circumferential wall main body portion 12a that is formed integrally with the rotary electric machine case 12 (end side wall 33) and a cylindrical member 34 as a separate body that is attached to an outer circumferential surface on an extension end side of the circumferential wall main body portion 12a. A space between the circumferential wall main body portion 12a and the cylindrical member 34 is sealed by a seal member 60 having an annular shape.

However, the entire first inner circumferential wall 32 may be formed integrally with the rotary electric machine case 12 (end side wall 33).

Further, the second side case 20 on a second end side in the axis direction of the stator core 14 includes a second inner circumferential wall 35 that faces the second liquid room 22. The second inner circumferential wall 35 protrudes in a cylindrical shape from an inner end portion in the radial direction of an end side wall 36 of the second side case 20 located at an outer end in the axis direction of the second liquid room 22 toward a second end surface in the axis direction of the rotor 11. In the case of the present embodiment, the second inner circumferential wall 35 is formed integrally with the rotary electric machine case 12 (end side wall 36).

However, the second inner circumferential wall 35 may be constituted of a circumferential wall main body portion that is integral with the rotary electric machine case 12 (end side wall 36) similarly to the first inner circumferential wall 32 and a cylindrical member as a separate body.

An annular partition wall 37 having a cylindrical shape is provided on an outer circumferential surface of the first inner circumferential wall 32 of the first side case 19 and an outer circumferential surface of the second inner circumferential wall 35 of the second side case 20. The annular partition wall 37 is formed of, for example, a resin material. However, the annular partition wall 37 can be also formed of another material such as a metal material. The annular partition wall 37 has a first end portion 37f that faces the inside of the first liquid room 21, a second end portion 37s that faces the inside of the second liquid room 22, and a partition wall main body portion 37b that is located between the first end portion 37f and the second end portion 37s and faces an inner circumferential surface of the stator core 14. The first end portion 37f is formed to have the same inner diameter as the partition wall main body portion 37b. The diameter of a middle portion in an extension direction of the second end portion 37s is reduced in a step manner with respect to the partition wall main body portion 37b.

An inner circumferential surface of the first end portion 37f is slidably fitted to an outer circumferential surface of the cylindrical member 34 of the first inner circumferential wall 32. An annular groove 38f is formed on the outer circumferential surface of the cylindrical member 34, and a seal member 39f having an annular shape such as an O-ring is attached to the annular groove 38f. A space between the cylindrical member 34 (first inner circumferential wall 32) and the first end portion 37f (annular partition wall 37) is sealed in a liquid-tight manner by the seal member 39f.

In the present embodiment, the first end portion 37f constitutes, at the inside of the first liquid room 21, a guide member that guides the cooling liquid in the first liquid room 21 to an opening of the slot 31 at a first end side in the axis direction of the stator core 14.

An inner circumferential surface of a reduced diameter section of the second end portion 37s is slidably fitted to an outer circumferential surface of the second inner circumferential wall 35. An annular groove 38s is formed on the outer circumferential surface of the second inner circumferential wall 35, and a seal member 39s having an annular shape such as an O-ring is attached to the annular groove 38s. A space between the second inner circumferential wall 35 and the second end portion 37s (annular partition wall 37) is sealed in a liquid-tight manner by the seal member 39f.

In the annular partition wall 37, as described above, the first end portion 37f is fitted in a liquid-tight manner to the first inner circumferential wall 32 of the first side case 19, and the second end portion 37s is fitted in a liquid-tight manner to the second inner circumferential wall 35 of the second side case 20. The annular partition wall 37 separates an inner region in the radial direction of the stator core 14 attached to the inside of the rotary electric machine case 12 from the outer circumferential surface of the rotor 11. Therefore, even if the cooling liquid 23 leaks out from the slot 31 of the stator core 14 to the inner region in the radial direction, it is possible to prevent the cooling liquid 23 from flowing into the outer circumferential surface side of the rotor 11.

Further, as shown in FIG. 2, an expansion portion 40 that expands further outward in the radial direction than an outer circumferential surface of the partition wall main body portion 37b is formed on an outer circumferential surface of the first end portion 37f of the annular partition wall 37. An end of the expansion portion 40 on the stator core 14 side stands outward in the radial direction in a step manner with respect to the outer circumferential surface of the partition wall main body portion 37b. The standing end surface is a contact seat 41 that is in contact with an end surface on a first end side in the axis direction of the stator core 14. The entire annular partition wall 37 is pressed to the second end side in the axis direction by a pressure of the cooling liquid 23 in the first liquid room 21 that acts on the first end portion 37f and a pressure of the cooling liquid 23 in the second liquid room 22 that acts on the second end portion 37s. At this time, the contact seat 41 is pressed to an end surface on one side in the axis direction of the stator core 14. As a result, the annular partition wall 37 is locked in a contact state by the stator core 14.

Here, the contact seat 41 (expansion portion 40) of the first end portion 37f shields part of the inner region in the radial direction of the slot 31 that opens to a first end surface in the axis direction of the stator core 14 from the first liquid room 21 side. The contact seat 41 (expansion portion 40) is formed at the first liquid room 21 side so as to cover a predetermined height range from an inner end in the radial direction of the slot 31 to the outside in the radial direction. Specifically, as shown in FIG. 3, the contact seat 41 (expansion portion 40) is formed such that an outer end portion in the radial direction has a protrusion height that is substantially in contact with an inner end in the radial direction of the coil 15 that is located at an innermost side in the slot 31 in an axis direction view.

In the present embodiment, the expansion portion 40 constitutes a shield portion (outflow regulation portion) that regulates an outflow of the cooling liquid 23 to the inner region in the radial direction of the slot 31 from the first liquid room 21.

In the slot 31 portion on a first end side in the axis direction of the stator core 14, as shown in FIG. 2, a flow path opening area S1 between the expansion portion 40 (outflow regulation portion) and the coil 15 that is located at an innermost side in the radial direction in the slot 31 is set to be smaller than a flow path opening area S2 between the coils 15 that are adjacent to each other in the slot 31. Specifically, the flow path opening area S1 having an area substantially corresponding to the recess groove 50 on one surface of the coil 15 is ensured between the expansion portion 40 (outflow regulation portion) and the coil 15 that is located at an innermost side in the radial direction. The flow path opening area S2 having an area obtained by substantially summing opening areas of two recess groove portions 50 of facing surfaces is ensured between the coils 15 that are adjacent to each other.

Further, as shown in FIG. 3, the annular partition wall 37 that is provided on the first side case 19 and the second side case 20 as described above is maintained in a state of being in contact with or being sufficiently close to the inner circumferential surface of the stator core 14. Further, the inner circumferential surface of the partition wall main body portion 37b of the annular partition wall 37 faces the outer circumferential surface of the rotor 11 with a small gap so as to be non-contact with the outer circumferential surface of the rotor 11.

In the rotary electric machine 1 having the configuration described above, when a current continuously flows through the coil 15 at the time of operation, the coil 15 generates heat and becomes a high temperature.

At this time, the cooling liquid 23 is introduced into the first liquid room 21 of the rotary electric machine 1 through the introduction port 24 from the circulation circuit 25. The cooling liquid 23 that is introduced into the first liquid room 21 flows in the first liquid room 21 and thereby cools a region on a first end portion side of the coil 15 that is exposed to the outside from the first end side in the axis direction of the stator core 14. Further, the cooling liquid 23 flows through the plurality of slots 31 of the stator core 14 from a first end side in the axis direction toward a second end side and flows into the second liquid room 22. The cooling liquid that flows through the inside of the slot 31 cools the coil 15 that is inserted through the inside of the slot 31. Further, the cooling liquid 23 that flows into the second liquid room 22 cools a region on the second end portion side of the coil 15 that is exposed to the outside from the second end side in the axis direction of the stator core 14 and is then caused to return to the circulation circuit 25 through the discharge port 26.

In the rotary electric machine 1, as described above, the stator 10 is constantly immersed in the cooling liquid 23 in the rotary electric machine case 12, and in that state, the cooling liquid 23 in the rotary electric machine case 12 is replaced through the circulation circuit 25. Therefore, the coil 15 of the stator 10 is efficiently cooled by the cooling liquid 23.

As described above, in the rotary electric machine 1 of the present embodiment, the first end portion 37f of the annular partition wall 37 is arranged on a first end side (a side that faces the first liquid room 21) in the axis direction of the stator core 14, and the expansion portion 40 (outflow regulation portion) of the first end portion 37f regulates the outflow of the cooling liquid 23 from the first liquid room 21 to the inner region in the radial direction. In the slot 31 portion on the first end side in the axis direction of the stator core 14, the flow path opening area S1 between the expansion portion 40 (outflow regulation portion) and the coil 15 that is located at the innermost side in the radial direction in the slot 31 is set to be smaller than the flow path opening area S2 between the coils 15 that are adjacent to each other in the slot 31. Therefore, the flow rate of the cooling liquid 23 that flows into the inner region in the radial direction of the slot 31 from the first liquid room 21 can be made smaller than the flow rate of the cooling liquid 23 that flows to the second liquid room 22 side through a gap between the coils 15 from the first liquid room 21.

Accordingly, when the rotary electric machine 1 of the present embodiment is employed, it is possible to prevent an excessive outflow of the cooling liquid 23 in the outer circumferential direction of the rotor 11 from the slot 31 of the stator core 14 by a simple configuration. Therefore, the rotary electric machine 1 of the present embodiment can contribute to the improvement of the energy efficiency.

Further, in the rotary electric machine 1 of the present embodiment, the first inner circumferential wall 32 and the second inner circumferential wall 35 are provided in the first liquid room 21 and the second liquid room 22, respectively, and the annular partition wall 37 that partitions a space between the inner circumferential surface of the stator core 14 and the outer circumferential surface of the rotor 11 is provided on the outer circumferential surface of the first inner circumferential wall 32 and the outer circumferential surface of the second inner circumferential wall 35. Therefore, even if the cooling liquid 23 that flows in the plurality of slots 31 flows out to the inner region in the radial direction of the stator core 14, the cooling liquid 23 does not flow to the outer circumferential surface of the rotor 11. Accordingly, when the present configuration is employed, it is possible to prevent the rotation of the rotor 11 from being hindered by the cooling liquid 23.

When the cooling liquid that flows in the plurality of slots 31 excessively flows out to the inner region in the radial direction of the slot 31, there is a concern that the annular partition wall 37 is deformed by being pressed inward in the radial direction by the cooling liquid 23. However, in the rotary electric machine 1 of the present embodiment, since the expansion portion 40 (outflow regulation portion) is provided on first end side in the axis direction of the annular partition wall 37, an excessive outflow of the cooling liquid 23 to the inner region in the radial direction of the slot 31 is prevented by the expansion portion 40. Accordingly, when the rotary electric machine 1 of the present embodiment is employed, it is possible to prevent the annular partition wall 37 from being deformed by being pressed inward in the radial direction by the cooling liquid 23. As a result, it becomes possible to maintain stable rotation performance of the rotary electric machine 1 for a long period of time.

Further, in the rotary electric machine 1 of the present embodiment, the first end portion 37f of the annular partition wall 37 functions as a guide member that guides the cooling liquid 23 to the slot 31 portion on a first end side in the axis direction of the stator core 14. Further, the expansion portion 40 that is provided on the first end portion 37f functions as a shield portion (outflow regulation portion) that is in contact with or is close to a first end surface in the axis direction of the stator core 14 and reduces the flow of the cooling liquid 23 to the inner region in the radial direction of the slot 31 portion at the first end side in the axis direction of the stator core 14. Accordingly, when the rotary electric machine 1 of the present embodiment is employed, it is possible to prevent an excessive outflow of the cooling liquid in the outer circumferential direction of the rotor 11 from the slot 31 without changing the shape of the slot 31 portion of the stator core 14. As a result, it becomes possible to manufacture the rotary electric machine 1 at low costs.

Further, the rotary electric machine 1 of the present embodiment has a configuration in which the first end portion 37f (guide member) of the annular partition wall 37 is locked in a contact state by the stator core 14. Therefore, when the stator core 14 (stator 10) vibrates, the annular partition wall 37 vibrates in the same phase as the stator core 14 (stator 10). Accordingly, even when the partition wall main body portion 37b of the annular partition wall 37 is close to the inner circumferential surface of the stator core 14, a friction due to the backlash or contact does not easily occur between the annular partition wall 37 and the stator core 14. The partition wall main body portion 37b of the annular partition wall 37 may be in contact with the inner circumferential surface of the stator core 14.

Therefore, when the rotary electric machine 1 of the present embodiment is employed, without generating abnormal noise or causing degradation of a member due to the friction, it is possible to sufficiently narrow an air gap between the stator core 14 and the rotor 11 and enhance the magnetic performance of the rotary electric machine 1.

In the rotary electric machine 1 of the present embodiment, the contact seat 41 that is in contact with the first end surface in the axis direction of the stator core 14 is provided on the first end portion 37f of the annular partition wall 37. When the cooling liquid 23 flows through the plurality of slots 31 from the first liquid room 21 to the second liquid room 22, the liquid pressure in the first liquid room 21 becomes higher than the liquid pressure in the second liquid room 22. Therefore, the first end portion 37f of the annular partition wall 37 is pressed in the direction of the second liquid room 22 by the pressure difference of the cooling liquids 23 in the first liquid room 21 and the second liquid room 22. In the rotary electric machine 1 of the present embodiment, at this time, the contact seat 41 of the first end portion 37f comes into contact with the end surface in the axis direction of the stator core 14, and thereby, the first end portion 37f is locked by the stator core 14.

Accordingly, when the rotary electric machine 1 of the present embodiment is employed, even when the space for locking the first end portion 37f (guide member) to the stator core 14 is narrow, the first end portion 37f can be reliably locked by the stator core 14. Further, in this case, since another component such as a fastening member is not required in order to lock the first end portion 37f to the stator core 14, an assembly work at the time of manufacturing the rotary electric machine 1 is also facilitated.

Further, in the rotary electric machine 1 of the present embodiment, the recess groove 50 that extends along the axis direction of the stator core 14 is formed on facing surfaces (surfaces that face the radial direction of the stator core 14) of the coils 15 that are arranged to be adjacent to each other in the slot 31. Therefore, it is possible to easily and reliably enlarge the flow path opening area S2 between the coils 15 that are arranged to be adjacent to each other in the slot 31. Accordingly, when the present configuration is employed, the flow path opening area S1 between the expansion portion 40 of the annular partition wall 37 and the coil 15 that is located at the innermost side in the radial direction in the slot 31 can be easily and reliably made smaller than the flow path opening area S2 between the coils 15 that are adjacent to each other.

### Second Embodiment

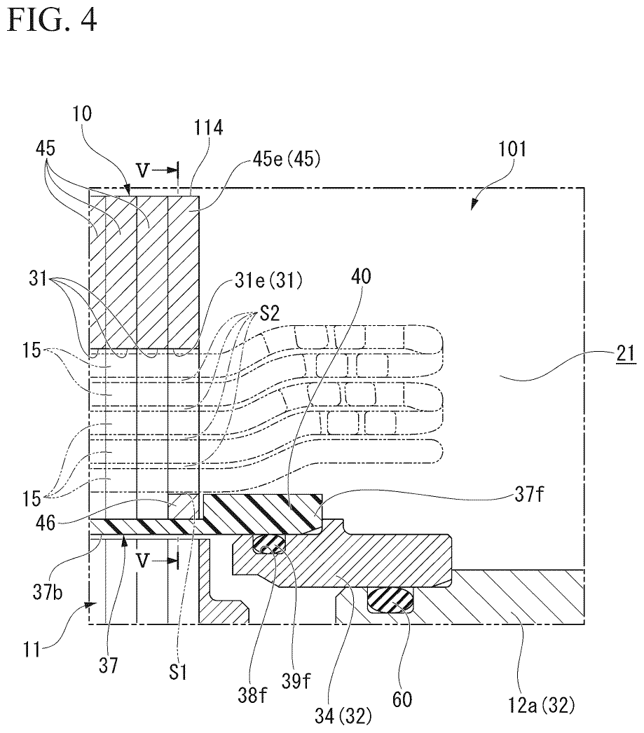

FIG. 4 is a cross-sectional view of a rotary electric machine 101 of the present embodiment corresponding to FIG. 2 of the first embodiment.

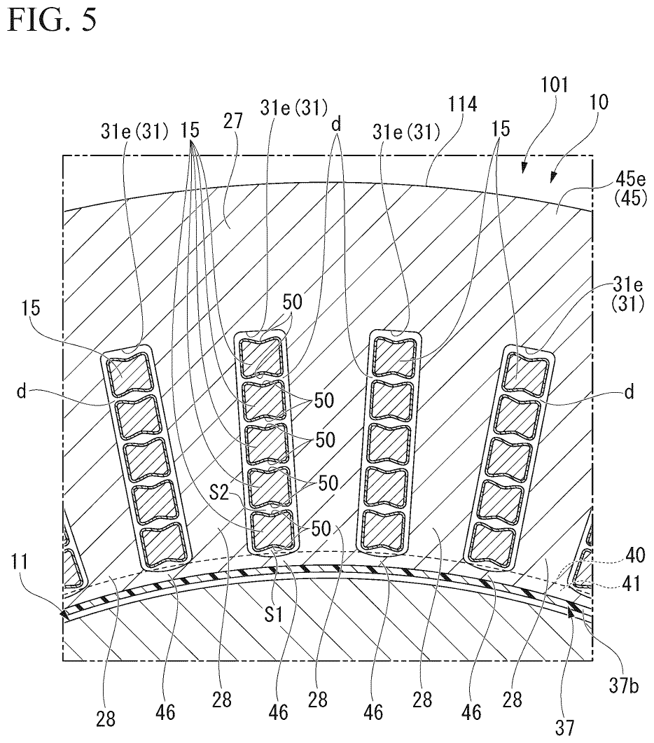

FIG. 5 is a cross-sectional view along a V-V line of FIG. 4 of the rotary electric machine 101 of the present embodiment.

In the rotary electric machine 101 of the present embodiment, a shape of a slot 31e of a steel plate 45e at a first end side (a side that faces the first liquid room 21) in the axis direction among a plurality of steel plates 45 that constitute a stator core 114 is different from a shape of another slot 31. The configuration of other parts is substantially similar to the configuration of the first embodiment described above.

The slot 31e of the steel plate 45e at a first end side in the axis direction is constituted of a closed slot in which an inner side in the radial direction of the stator core 114 is closed. That is, an inner end in the radial direction of a coil insertion portion that extends along the radial direction of the slot 31e is closed by a slot close portion 46. Therefore, an end portion of each slot 31e is not opened at an inner circumferential surface of the steel plate 45e on a first end side in the axis direction. The inner circumferential surface of the steel plate 45e has a continuous circumferential surface shape.

The partition wall main body portion 37b of the annular partition wall 37 is fitted to the inner circumferential surface of the steel plate 45e. In the present embodiment, the first end portion 37f of the annular partition wall 37 that functions as a guide member is locked in a contact state by the inner circumferential surface of the stator core 114 via the partition wall main body portion 37b.

The slot close portion 46 of the steel plate 45e at a first end side in the axis direction constitutes, at one end portion in the axis direction of the stator core 114, an outflow regulation portion that regulates an outflow of the cooling liquid from the first liquid room 21 to an inner region in the radial direction of the slot 31.

The slot 31 of a steel plate 45 other than the steel plate 45e at a first end side in the axis direction is constituted by an open slot that opens inward in the radial direction.

In the present embodiment, only one steel plate 45e at a first end side in the axis direction is a closed slot; however, a plurality of steel plates 45 at a first end side in the axis direction may be the closed slot.

In the slot 31e portion of the steel plate 45e at a first end side in the axis direction, a flow path opening area S1 between the slot close portion 46 (outflow regulation portion) and the coil 15 that is located at an innermost side in the radial direction in the slot 31e is set to be smaller than a flow path opening area S2 between the coils 15 that are adjacent to each other in the slot 31e. Specifically, in the case of the present embodiment, the flow path opening area S1 having an area substantially corresponding to the recess groove 50 on one surface of the coil 15 is ensured between the slot close portion 46 (outflow regulation portion) and the coil 15 that is located at an innermost side in the radial direction. The flow path opening area S2 having an area obtained by substantially summing opening areas of two recess groove portions 50 of facing surfaces is ensured between the coils 15 that are adjacent to each other.

As described above, in the rotary electric machine 101 of the present embodiment, in the slot 31e portion on the first end side in the axis direction of the stator core 114, the flow path opening area S1 between the slot close portion 46 (outflow regulation portion) and the coil 15 that is located at the innermost side in the radial direction in the slot 31e is set to be smaller than the flow path opening area S2 between the coils 15 that are adjacent to each other in the slot 31. Therefore, the flow rate of the cooling liquid that flows into the inner region in the radial direction of the slot 31 from the first liquid room 21 can be made smaller than the flow rate of the cooling liquid that flows to the second liquid room side through a gap between the coils 15 from the first liquid room 21.

Accordingly, when the rotary electric machine 101 of the present embodiment is employed, it is possible to prevent an excessive outflow of the cooling liquid in the outer circumferential direction of the rotor 11 from the slot 31 of the stator core 114 by a simple configuration.

Further, the rotary electric machine 101 of the present embodiment has a configuration that is substantially similar to that of the first embodiment except for the shape of the slot 31e of the steel plate 45e at a first end side in the axis direction and therefore can obtain advantages similar to those of the first embodiment described above.

### Third Embodiment

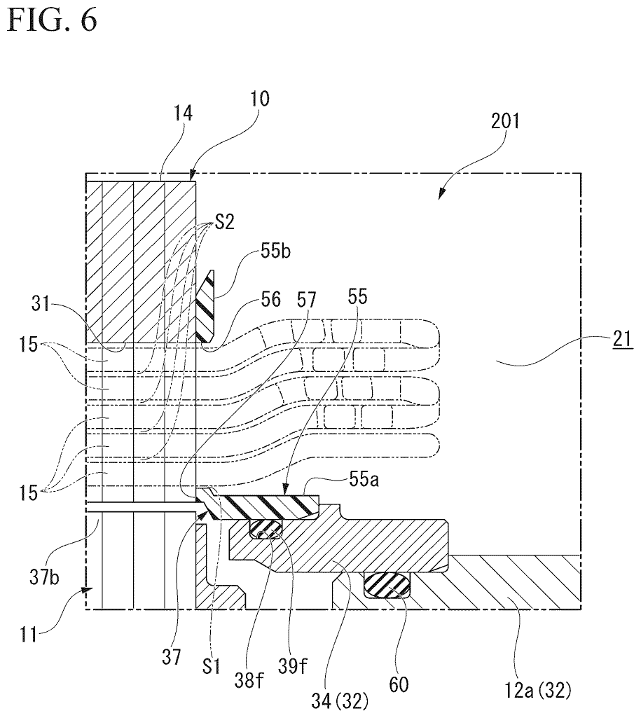

FIG. 6 is a cross-sectional view of a rotary electric machine 201 of the present embodiment corresponding to FIG. 2 of the first embodiment.

In the rotary electric machine 201 of the present embodiment, the slot 31 of the stator core 14 is an open slot that opens inward in the radial direction with respect to all steel plates similarly to the first embodiment. The rotary electric machine 201 of the present embodiment does not include the annular partition wall 37 as in the first embodiment and the second embodiment. In the rotary electric machine 201, a guide member 55 having an annular shape is locked in a fit state by the first inner circumferential wall 32 (cylindrical member 34) that faces the inside of the first liquid room 21. The guide member 55 is formed of, for example, a resin material.

The guide member 55 includes a cylindrical wall 55a that is fitted to an outer circumferential surface of the first inner circumferential wall 32 (cylindrical member 34) and a flange wall 55b that projects outward in the radial direction from an end portion of the cylindrical wall 55a on a side that faces an end surface of the stator core 14. A plurality of coil insertion holes 56 that penetrate in a plate thickness direction is formed on the flange wall 55b. The coil insertion hole 56 is a hole that has a substantially rectangular shape and extends along the radial direction. The coil insertion hole 56 is formed at a position corresponding to the plurality of slots 31 of the stator core 14. End portions of the plurality of coils 15 that are inserted into each slot 31 of the stator core 14 is inserted through each coil insertion hole 56 so as to be pulled out to the first liquid room 21 side. The flange wall 55b is in contact with a first end surface (end surface on a side that faces the first liquid room 21) in the axis direction of the stator core 14.

An edge portion 57 on an inner side in the radial direction of each coil insertion hole 56 of the flange wall 55b is in contact with an inner circumferential edge portion of an end surface of the stator core 14. Therefore, the edge portion 57 of each coil insertion hole 56 shields the inner region in the radial direction of the corresponding slot 31 of the stator core 14 from the first liquid room 21 side.

In the present embodiment, the edge portion 57 on the inner side in the radial direction of the coil insertion hole 56 of the flange wall 55b of the guide member 55 constitutes a shield portion (outflow regulation portion). The edge portion 57 on the inner side in the radial direction of the coil insertion hole 56 regulates the outflow of the cooling liquid from the first liquid room 21 to the inner region in the radial direction of the slot 31. Further, the guide member 55 functions so as to guide, at the inside of the first liquid room 21, the cooling liquid to the slot 31 on a first end side in the axis direction of the stator core 14.

In the slot 31 portion on a first end side in the axis direction of the stator core 14, a flow path opening area S1 between the edge portion 57 on the inner side in the radial direction of the coil insertion hole 56 of the guide member 55 and the coil 15 that is located at an innermost side in the radial direction in the slot 31 is set to be smaller than a flow path opening area S2 between the coils 15 that are adjacent to each other in the slot 31.

As described above, in the rotary electric machine 201 of the present embodiment, in the slot 31 portion on the first end side in the axis direction of the stator core 14, the flow path opening area S1 between the edge portion 57 of the guide member 55 and the coil 15 that is located at the innermost side in the radial direction is set to be smaller than the flow path opening area S2 between the coils 15. Therefore, the flow rate of the cooling liquid that flows into the inner region in the radial direction of the slot 31 from the first liquid room 21 can be made smaller than the flow rate of the cooling liquid that flows to the second liquid room side through a gap between the coils 15 from the first liquid room 21.

Accordingly, when the rotary electric machine 201 of the present embodiment is employed, it is possible to prevent an excessive outflow of the cooling liquid in the outer circumferential direction of the rotor 11 from the slot 31 of the stator core 14 by a simple configuration.

In the case of the present embodiment, since the annular partition wall is not arranged between an inner circumferential surface of the stator core 14 and an outer circumferential surface of the rotor 11, part of the cooling liquid that has flowed out to the inside in the radial direction of the slot 31 may flow in a direction of the outer circumferential surface of the rotor 11. However, in the present embodiment, since the flow rate of the cooling liquid that flows out from the first liquid room 21 to the inner region in the radial direction of the slot 31 is reduced (the flow path opening area S1<the flow path opening area S2) by the edge portion 57 of the guide member 55, it is possible to prevent the outflow of the cooling liquid in the outer circumferential surface direction of the rotor 11 from becoming excessive and prevent the rotation of the rotor 11 from being blocked by the cooling liquid.

### Fourth Embodiment

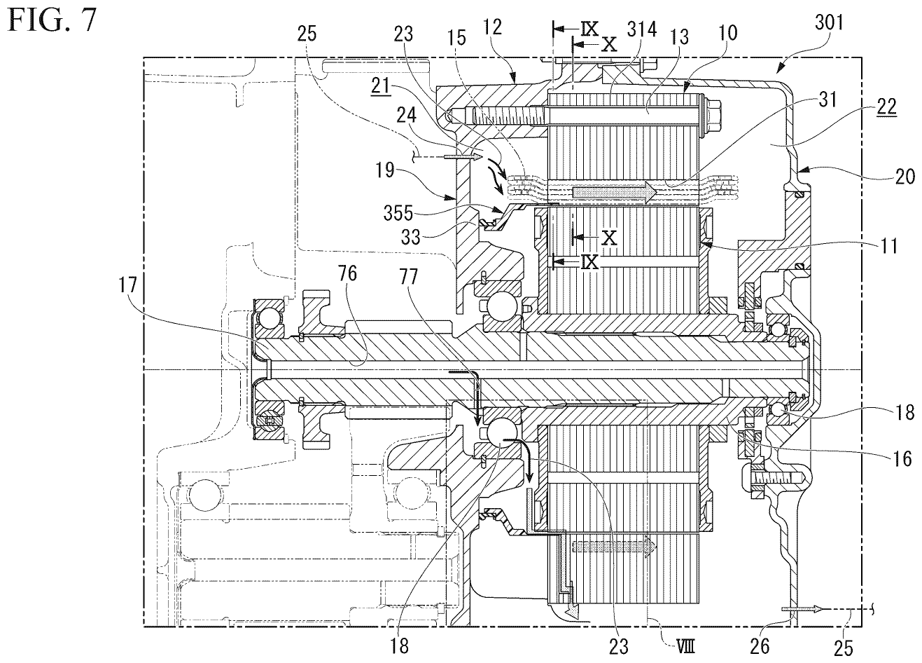

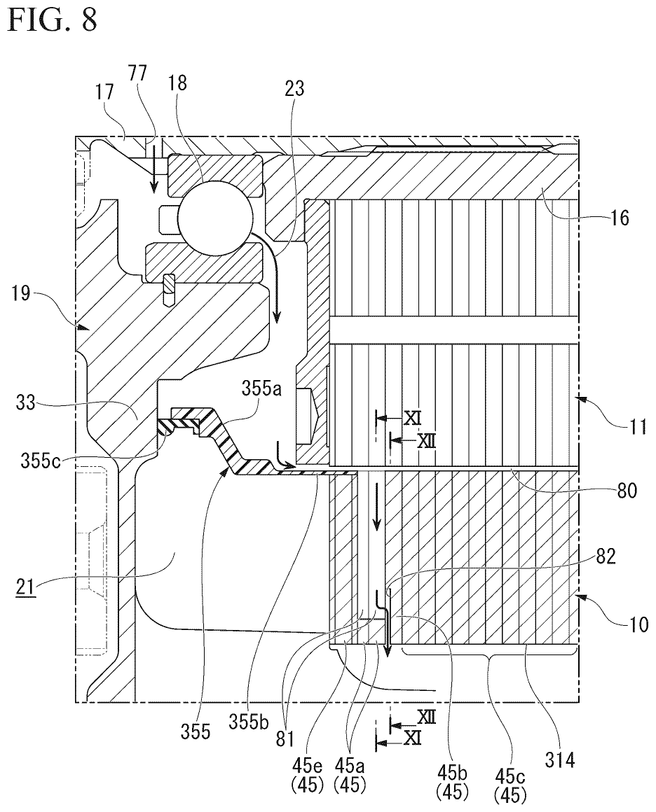

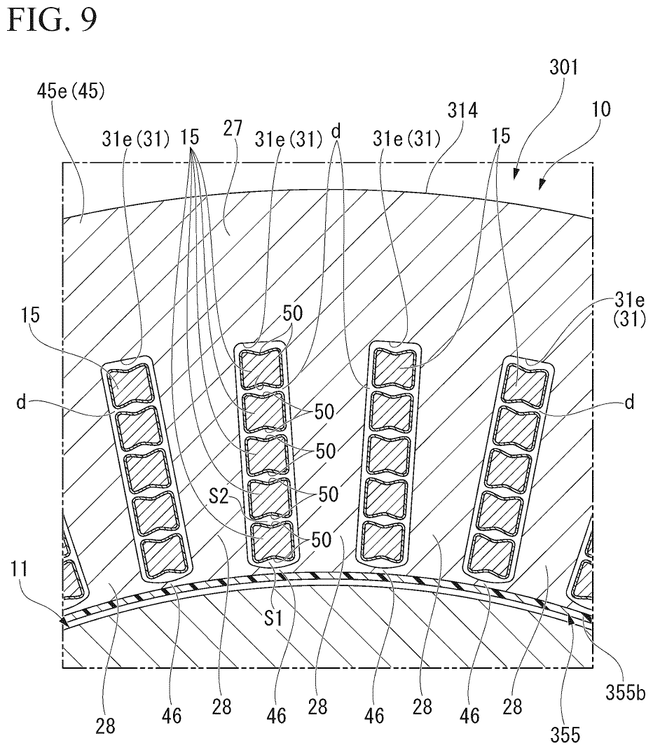

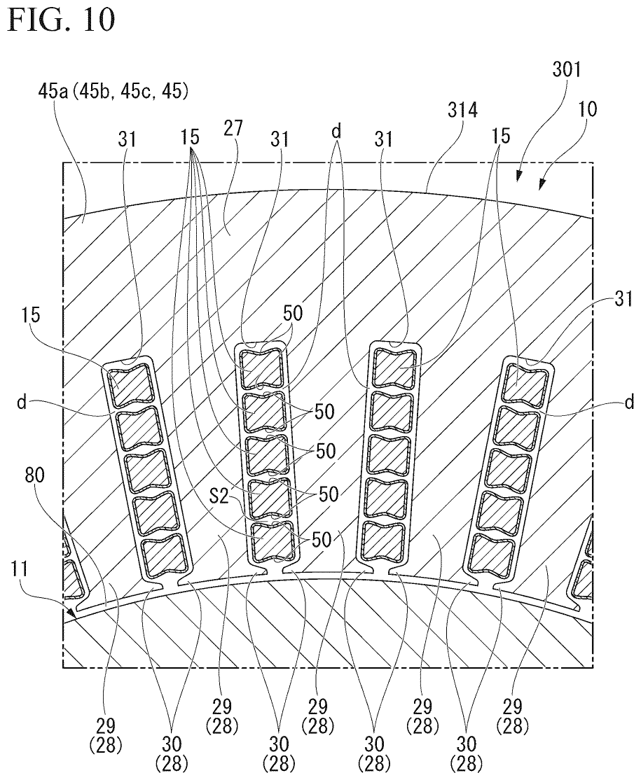

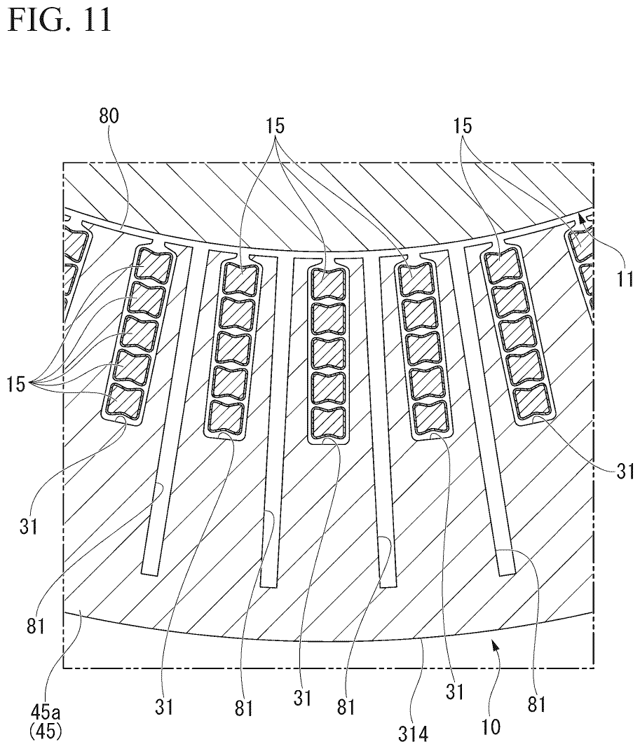

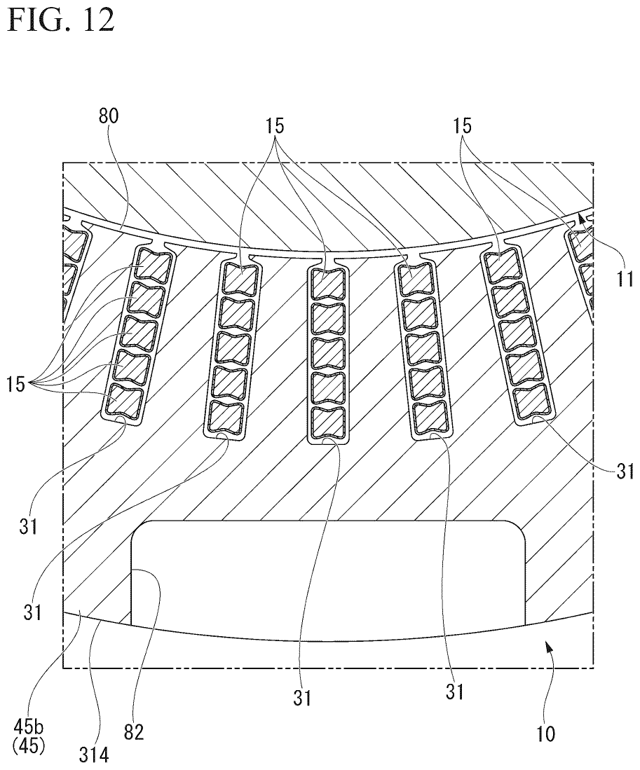

FIG. 7 is a longitudinal cross-sectional view of a rotary electric machine 301 of the present embodiment, and FIG. 8 is an enlarged cross-sectional view of a VIII portion of FIG. 7. FIG. 9 is a cross-sectional view along a IX-IX line of FIG. 7, and FIG. 10 is a cross-sectional view along a X-X line of FIG. 7. Further, FIG. 11 is a cross-sectional view along a XI-XI line of FIG. 8, and FIG. 12 is a cross-sectional view along a XII-XII line of FIG. 8.

In the rotary electric machine 301 of the present embodiment, similarly to the first embodiment, the stator 10 and the rotor 11 are accommodated in the rotary electric machine case 12, and the stator 10 is fixed to the inside of the rotary electric machine case 12 by the bolt 13. The rotor 11 is rotatably supported integrally by the rotation shaft 17 via the sleeve 16. Further, the rotation shaft 17 is rotatably supported by the rotary electric machine case 12 via the bearing 18. A supply passage 76 of the cooling liquid 23 (lubricating liquid) is provided on an axis center portion of the rotation shaft 17. A supply hole 77 that penetrates in the radial direction and supplies the cooling liquid 23 in the supply passage 76 to the bearing 18 is formed in the vicinity of a support position of the bearing 18 of the rotation shaft 17.

The stator 10 includes a stator core 314 having a cylindrical shape and a plurality of coils 15 that are wound around the stator core 314. As shown in FIG. 8, the stator core 314 is formed by laminating a plurality of steel plates 45 (electromagnetic steel plates) in the axis direction. In the stator core 314, as shown in FIG. 9 and FIG. 10, a back yoke 27 having a cylindrical shape and a plurality of teeth portions 28 that protrude inward in the radial direction from an inner circumferential portion of the back yoke 27 are integrally formed. The slot 31 is formed between the teeth portions 28 that are adjacent to each other in the circumferential direction. The plurality of coils 15 are wound around the teeth portion 28 via the slot 31.

The rotary electric machine case 12 has a first side case 19 and a second side case 20. The first side case 19 covers a first end surface in the axis direction of the stator core 314 and an exposure portion of the coil 15 that protrudes from the first end surface from the outside. The first side case 19 forms a first liquid room 21 having an annular shape together with the first end surface in the axis direction of the stator core 314.

The second side case 20 covers a second end surface in the axis direction of the stator core 314 and an exposure portion of the coil 15 that protrudes from the second end surface from the outside. The second side case 20 forms a second liquid room 22 having an annular shape together with the second end surface in the axis direction of the stator core 314. An introduction port 24 for introducing a cooling liquid 23 into the first liquid room 21 is formed on the first side case 19. A discharge port 26 for discharging the cooling liquid 23 in the second liquid room 22 to the outside is formed on the second side case 20. The introduction port 24 and the discharge port 26 are connected to a circulation circuit 25.

The cooling liquid that is introduced into the first liquid room 21 from the circulation circuit 25 flows into the second liquid room 22 through the slot 31 of the stator core 314 while cooling the coil 15, and is caused to return to the circulation circuit 25 through the discharge port 26 from the second liquid room 22.

As shown in FIG. 8 and FIG. 9, a slot 31e (31) of a steel plate 45e that is arranged on one end portion in the axis direction among steel plates 45 that constitute the stator core 314 is constituted of a closed slot. That is, in the slot 31e of the steel plate 45e on the end portion, an inner end in the radial direction of a coil insertion portion that extends along the radial direction is closed by a slot close portion 46. Further, the remaining steel plates 45a, 45b, 45c that constitute the stator core 314 is constituted of an open slot that opens inward in the radial direction.

As shown in FIG. 9 and FIG. 10, the coil 15 that is inserted into the slot 31 of the stator core 314 is constituted of a rectangular wire having a substantially rectangular shape in a cross section. In each coil 15, a recess groove 50 that extends along the axis direction of the stator core 314 is formed on a surface that faces in the radial direction in a state of being inserted in the slot 31. Further, a gap d that allows the cooling liquid 23 to flow from the first liquid room 21 to the second liquid room 22 is ensured between the slot 31 and the coil 15 and between the coils 15 that are adjacent to each other.

The slot close portion 46 of the steel plate 45e at a first end side in the axis direction constitutes, at one end portion in the axis direction of the stator core 314, an outflow regulation portion that regulates an outflow of the cooling liquid 23 from the first liquid room 21 to an inner region in the radial direction of the slot 31.

As shown in FIG. 9, in the slot 31e portion of the steel plate 45e at a first end side in the axis direction, a flow path opening area S1 between the slot close portion 46 (outflow regulation portion) and the coil 15 that is located at an innermost side in the radial direction in the slot 31e is set to be smaller than a flow path opening area S2 between the coils 15 that are adjacent to each other in the slot 31e. Specifically, the flow path opening area S1 having an area substantially corresponding to the recess groove 50 on one surface of the coil 15 is ensured between the slot close portion 46 (outflow regulation portion) and the coil 15 that is located at an innermost side in the radial direction. The flow path opening area S2 having an area obtained by substantially summing opening areas of two recess groove portions 50 of facing surfaces is ensured between the coils 15 that are adjacent to each other.

Further, a guide member 355 having an annular shape is attached to an inner circumferential surface on a first end side in the axis direction of the stator core 314. The guide member 355 is constituted of a guide main body 355a made of a hard resin and an annular seal 355c that is made of an elastomer and is supported by a guide main body 355a. In the guide main body 355a, one end portion 355b in the axis direction is formed to be thin, and the end portion 355b adheres and is fixed in a fit state to an inner circumferential surface of an end portion in the axis direction of the stator core 314.

Specifically, the end portion 355b of the guide main body 355a is fixed to an inner circumferential surface of the steel plate 45e at the end portion of the stator core 314. The annular seal 355c is joined to another end portion in a thickness direction of the guide main body 355a.

The guide member 355 extends from one end portion in the axis direction of the stator core 314 toward the end side wall 33 of the first side case 19, and the annular seal 355c is in close contact with an inner surface of the end side wall 33. The guide member 355 constitutes a partition wall that has an annular shape and that forms and separates an inner region in the radial direction of the first liquid room 21.

Further, the inner circumferential surface of the steel plate 45e at the end portion in the axis direction of the stator core 314 is formed to have a larger diameter than inner circumferential surfaces of other steel plates 45a, 45b, 45c as shown in FIG. 8. More specifically, the inner circumferential surface of the steel plate 45e is formed to have a larger diameter than the inner circumferential surface of the other steel plates 45a, 45b, 45c by a thickness of the thin end portion 355b of the guide main body 355a. Thereby, a gap having the same width as a gap 80 between the inner circumferential surfaces of the other steel plates 45a, 45b, 45c of the stator core 314 and the outer circumferential surface of the rotor 11 is ensured between the inner circumferential surface of the end portion 355b of the guide main body 355a and the outer circumferential surface of the rotor 11.

As shown in FIG. 8 and FIG. 11, a plurality of slits 81 that extend outward (vertically downward) in the radial direction from the inner circumferential surface is formed on two steel plates 45a that are adjacent to the steel plate 45e at the end portion of the stator core 314. The plurality of slits 81 are formed only in a partial region of the stator core 314 below the rotation shaft 17. The slit 81 is arranged at both side positions in the circumferential direction of the plurality of slots 31 that are located at a lower position than the rotation shaft 17 and extends to a position (lower position) closer to the outer circumferential surface of the stator core 314 than the slot 31.

As shown in FIG. 8 and FIG. 12, a cutout groove 82 that opens toward the outer circumferential surface of the stator core 314 is formed on the steel plate 45b that is adjacent, at the inner side in the axis direction, to the steel plate 45a of the stator core 314. The cutout groove 82 opens vertically downward below the rotation shaft 17. Further, the cutout groove 82 communicates with the plurality of slits 81 of the adjacent steel plate 45a. The plurality of slits 81 and the cutout groove 82 constitute a cooling liquid escape portion for discharging the cooling liquid 23 that has flowed into the gap 80 between the inner circumferential surface of the stator core 314 and the outer circumferential surface of the rotor 11 to the outside of the stator 10. The cooling liquid 23 that has flowed into the gap 80 between the inner circumferential surface of the stator core 314 and the outer circumferential surface of the rotor 11 is discharged to a bottom portion of the rotary electric machine case 12 through the slit 81 and the cutout groove 82.

As shown in FIG. 8, the cooling liquid 23 that has lubricated the bearing 18 through the supply passage 76 and the supply hole 77 of the rotation shaft 17 is guided to the guide main body 355a of the guide member 55 and is discharged to the bottom portion of the rotary electric machine case 12 through the gap 80, the slit 81, and the cutout groove 82.

As described above, in the rotary electric machine 301 of the present embodiment, in the slot 31e portion on the first end side in the axis direction of the stator core 314, the flow path opening area S1 between the slot close portion 46 (outflow regulation portion) and the coil 15 that is located at the innermost side in the radial direction in the slot 31e is set to be smaller than the flow path opening area S2 between the coils 15 that are adjacent to each other in the slot 31. Therefore, the flow rate of the cooling liquid 23 that flows into the inner region in the radial direction of the slot 31 from the first liquid room 21 can be made smaller than the flow rate of the cooling liquid 23 that flows to the second liquid room side through a gap between the coils 15 from the first liquid room 21.

Accordingly, when the rotary electric machine 301 of the present embodiment is employed, it is possible to prevent an excessive outflow of the cooling liquid 23 in the outer circumferential direction of the rotor 11 from the slot 31 of the stator core 314.

Further, in the case of the rotary electric machine 301 of the present embodiment, the slots 31 that are formed on the steel plates 45a, 45b, 45c other than the steel plate 45e at a first end side in the axis direction of the stator core 314 is constituted of an open slot that opens inward in the radial direction. Therefore, part of the cooling liquid 23 that has flowed out to the inside in the radial direction of the slot 31 may flow into the gap 80 between the inner circumferential surface of the stator core 314 and the outer circumferential surface of the rotor 11. However, in the present embodiment, since the flow rate of the cooling liquid that flows out from the first liquid room 21 to the inner region in the radial direction of the slot 31 is reduced (the flow path opening area S1<the flow path opening area S2) by the slot close portion 46 of the steel plate 45e at the end portion, it is possible to reduce an outflow amount of the cooling liquid 23 in the outer circumferential surface direction of the rotor 11.

Further, in the rotary electric machine 301 of the present embodiment, the slit 81 and the cutout groove 82 which are a cooling liquid escape portion are provided on the steel plates 45a, 45b which are an open slot as a part of the steel plates. Therefore, part of the cooling liquid that has passed through the closed slot at a first end side in the axis direction of the stator core 314 is discharged to the outside through the slit 81 and the cutout groove 82 that are provided on the steel plates 45a, 45b as a part of the steel plates. Accordingly, when the rotary electric machine 301 of the present embodiment is employed, it is possible to further reliably prevent the cooling liquid 23 that has flowed into the open slot of the stator core 314 from excessively flowing out to the outer circumferential surface side of the rotor 11.

Specifically, in the rotary electric machine 301 of the present embodiment, the slit 81 and the cutout groove 82 are provided so as to extend vertically downward at a lower position than the rotation shaft 17 of the steel plates 45a, 45b which are the open slot. Therefore, the excessive cooling liquid 23 can be reliably discharged to the outside of the stator core 314 by utilizing the gravitational force that acts on the cooling liquid 23. Further, when the present configuration is employed, the discharge flow rate of the cooling liquid 23 from the stator core 314 can be easily adjusted by changing the shape, the size, or the like of the slit 81 or the cutout groove 82.

Further, the rotary electric machine 301 of the present embodiment employs a configuration in which the guide main body 355a of the guide member 355 is fixed to the end portion in the axis direction of the stator core 314, and the annular seal 355c of the guide member 355 is in close contact with the end side wall of the first side case 19. In the case of this configuration, the inner region in the radial direction of the first liquid room 21 can be formed and separated by the guide member 355 without providing an inner circumferential wall that is difficult to manufacture on the first side case 19 side. Accordingly, when the present configuration is employed, it is possible to facilitate the manufacturing of the rotary electric machine case 12.

The present invention is not limited to the embodiments described above, and various design changes can be made without departing from the scope of the invention. For example, in the fourth embodiment described above, the cooling liquid escape portion is formed of the plurality of slits 81 and the cutout groove 82; however, the configuration of the cooling liquid escape portion is not limited to the slit 81 and the cutout groove 82. It is enough that the cooling liquid escape portion can discharge part of the cooling liquid 23 from the open slit to the outside. For example, a configuration of only a slot or a configuration of only a cutout groove may be used for the cooling liquid escape portion.

What is claimed is:

1. A rotary electric machine comprising:
a stator having: a stator core which has a cylindrical shape and in which a plurality of teeth portions and a plurality of slots are provided alternately on an inner circumferential portion; and a plurality of coils that are wound around each of the teeth portions through the slots;
a rotor that is rotatably arranged on an inside in a radial direction of the stator;
a first liquid room that is provided so as to face a first end surface in an axis direction of the stator core; and
a second liquid room that is provided so as to face a second end surface in the axis direction of the stator core,
wherein a cooling liquid that is introduced into the first liquid room flows into the second liquid room through the plurality of slots,
an outflow regulation portion that regulates an outflow of the cooling liquid from the first liquid room to an inner region in the radial direction of the slot is provided on at least a first end side in the axis direction of the stator core, and
in a slot portion on a first end side in the axis direction, a flow path opening area between the outflow regulation portion and a coil among the plurality of coils that is located at an innermost side in the radial direction in a slot among the plurality of slots is set to be smaller than a flow path opening area between the coils that are adjacent to each other in the slot.

2. The rotary electric machine according to claim 1, comprising:
at an inside of the first liquid room, a guide member that guides the cooling liquid to the slot on the first end side in the axis direction of the stator core,
wherein the guide member has a shield portion that is in contact with or is close to the first end surface in the axis direction of the stator core and reduces a flow of the cooling liquid to the inner region in the radial direction of the slot at the first end side in the axis direction of the stator core, and
the shield portion constitutes the outflow regulation portion.

3. The rotary electric machine according to claim 2,
wherein the guide member is locked in a contact state by the stator core.

4. The rotary electric machine according to claim 3,
wherein a contact seat that is in contact with the first end surface in the axis direction of the stator core is provided on the guide member.

5. The rotary electric machine according to claim 2,
wherein an inner side in the radial direction of the first liquid room is formed and separated by a first inner circumferential wall,
an inner side in the radial direction of the second liquid room is formed and separated by a second inner circumferential wall,
an annular partition wall that partitions an inner circumferential surface of the stator core and an outer circumferential surface of the rotor is provided on an outer circumferential surface of the first inner circumferential wall and an outer circumferential surface of the second inner circumferential wall, and
the shield portion is formed on part of the annular partition wall.

6. The rotary electric machine according to claim 1,
wherein a portion of the slot that is arranged on the first end side in the axis direction of the stator core is constituted of a closed slot in which an inner side in the radial direction of the stator core is closed, and
a slot close portion that closes the inner side in the radial direction of the closed slot constitutes the outflow regulation portion.

7. The rotary electric machine according to claim 6,
wherein the slot at a further inner side in the axis direction than a portion as the closed slot is constituted of an open slot that opens to an inner circumferential side of the stator core, and
a cooling liquid escape portion that communicates with a portion of the slot as the open slot is provided on the stator core.

8. The rotary electric machine according to claim 1,
wherein a recess groove that extends along the axis direction of the stator core is formed on facing surfaces of the coils that are arranged to be adjacent to each other in the slot.
